(19) United States
(12) Patent Application Publication
(10) Pub. No.: US 2004/0111972 A1
(43) Pub. Date: Jun. 17, 2004

(54) Sill-free door with lowerable seal

(75) Inventor: Andreas Dintheer, Nurensdorf (CH)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: Planet GDZ AG

(21) Appl. No.: 10/320,139

(22) Filed: Dec. 16, 2002

(51) Int. Cl. E06B 1/70

(52) U.S. Cl. 49/470

(57) ABSTRACT

In the case of a sill-free door with at least one door leaf (1) and with a lowerable seal (D), the lowereable seal (D) is arranged beneath a bottom end surface (10) of the door leaf (1). This seal has, at its top end, a bearing surface (20, 61) which is adhesively bonded to the bottom end surface (10) of the door leaf (1). This arrangement and fastening make possible, in particular for glass doors, improved sound insulation and a space-saving and aesthetically pleasing configuration of sill-free doors.

### TECHNICAL FIELD

The invention relates to a sill-free door with a lowerable seal according to the preamble of patent claim 1.

### PRIOR ART

Sill-free doors with lowerable seals are known, for example, from DE-A-20,002,108.7 U, lowerable seals are known from EP-A-0,338,974 and a lowering mechanism for such seals is known from DE-A-195,16,530.

U.S. Pat. No. 4,805,345 discloses a lowerable door seal which is fastened on a bottom end surface of the door. U.S. Pat. No. 4,425,738 discloses a door seal which is designed as an angle element, a first leg of the angle forming a bearing surface for the bottom end surface of the door and a second angle serving as a stop surface for the door leaf. EP-A-609,755 describes a lowerable door seal which is retained in a profile rail which, in addition, has a locking rod passing through it.

It is customary, however, for the lowerable seal to be positioned in a groove provided on the underside of the door leaf. If this is not possible, then the seal is fastened on a side surface of the door leaf by means of angle structures, the seal projecting in relation to the door leaf.

A fastening method according to FIG. 5 is known for glass doors. The seal has a laterally arranged U-profile rail P for securing the glass pane G, the glass pane usually being introduced into the profile rail by a depth of up to 40 mm. This fastening method has a number of disadvantages. For example, part of the glass pane is concealed by the profile rail, which reduces the size of the translucent surface. As a result of the U-profile rail, the vertical sealing surface F has an undesirable step S and the horizontal spacing H between the sealing surfaces is relatively large. Typical values for H are around 24 mm. Such a large spacing between the sealing surfaces, however, prevents effective sound insulation. In addition, the overall thickness of the door in the bottom region is even greater than the spacing between the sealing surfaces, which, from the point of view of aesthetics, is not really desirable.

Furthermore, the architects and customers like doors to satisfy certain requirements in terms of aesthetics.

For example glass doors in particular are to have the smallest possible number of fixtures, if any at all, but are nevertheless to ensure insulation against sound and cold in the region of the door gap.

### DESCRIPTION OF THE INVENTION

The object of the invention is thus to provide a sill-free door with a lowerable seal which eliminates the abovementioned disadvantages and may be configured, in particular, as a glass door.

This object is achieved by a sill-free door having the features of patent claim 1.

The sill-free door according to the invention has a lowerable seal which is arranged beneath a bottom end surface of a door leaf and is integrally connected to said end surface by way of a bearing surface. It is preferably adhesively bonded to said end surface. The seal is usually mounted on a bottom end surface. It is also possible, however, for it to be fastened on a top or lateral end surface, in order to provide sealing in the upward or lateral directions.

A stepless vertical sealing surface is thus achieved even in a groove-free door, the overall sealing surface being relatively narrow. This results in improved sound insulation. In addition, the glass surface is only concealed to a minimal extent, if at all, by the lowerable seal. Furthermore, the width of the door at the bottom is minimized and is optimally the same as the width of the door leaf.

In a straightforward embodiment, a guide profile of the lowerable seal is adhesively bonded to the bottom end surface of the door leaf. In a further embodiment, the guide profile is retained in an accommodating profile which is adhesively bonded to the door leaf.

Further advantageous embodiments can be gathered from the dependent patent claims.

### BRIEF DESCRIPTION OF THE FIGURES

The subject matter of the invention is explained hereinbelow with reference to preferred exemplary embodiments which are illustrated in the attached drawing, in which:

FIG. 1 shows a lateral end view of the lowermost part of a first embodiment of a door according to the invention;

FIG. 2 shows a second embodiment of the door;

FIG. 3 shows a third embodiment of the door;

FIG. 4 shows a fourth embodiment of the door;

FIG. 5 shows a view of the lowermost part of a door according to the prior art with a visualized sealing surface;

FIG. 6 shows a view of the lowermost part of a door according to the invention with a visualized sealing surface; and

FIG. 7 shows a lateral end view of the lowermost part of a fifth embodiment of a door according to the invention.

### METHODS OF IMPLEMENTING THE INVENTION

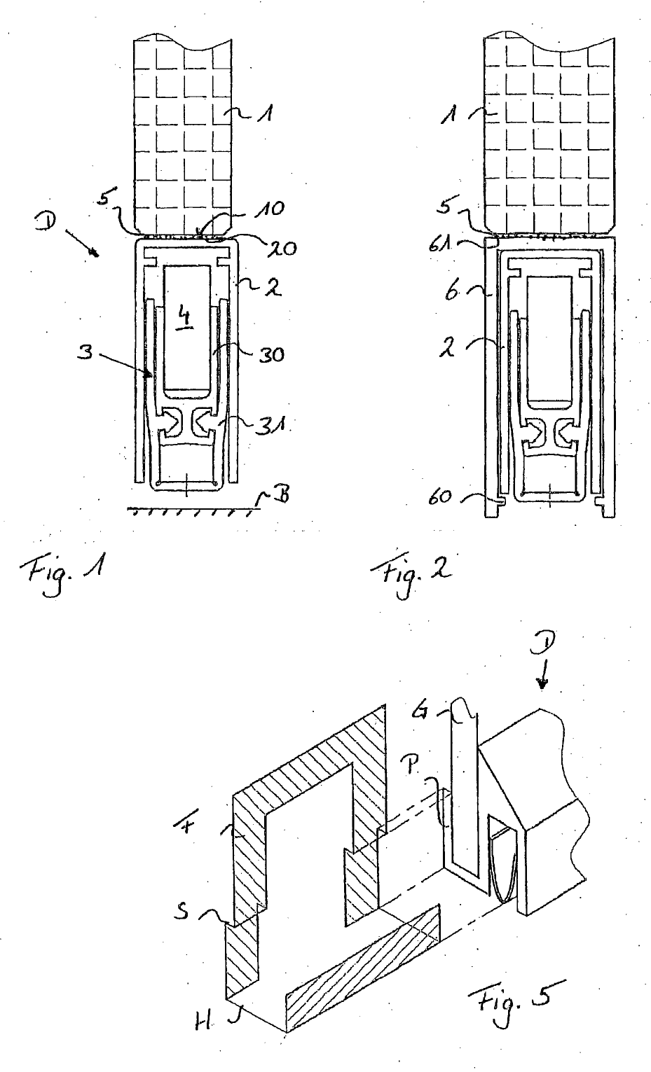

FIG. 1 illustrates a first straightforward embodiment of the door according to the invention. It has a lowereable seal D, as is disclosed, for example, in EP-A-0,338,974. It essentially comprises a u-shaped guide-profile rail 2, which is open in the downward direction, a sealing strip 3, which can be displaced relative to the guide profile, and a lowering mechanism 4 for displacing the sealing strip 3 when the door is closed and opened. The sealing strip 3 has a carrier-profile rail 30 and an elastomeric sealing profile 31, which is arranged thereon, it being possible for the carrier profile 30 to be connected to the lowering mechanism 4, and the sealing profile 31, in the closed state, resting on the floor B. This seal D merely represents a preferred example. It is also possible, however, for the door according to the invention to be provided with other types of lowerable seal.

The guide profile 2 has a planar bearing surface 20 at its top end. By means of this bearing surface 20, the seal D is integrally connected, preferably adhesively bonded, to a planar bottom end surface 10 of a door leaf 1. A suitable adhesive 5 is constituted by all adhesives which are suitable for bonding the respective materials. The guide profile may be produced, for example, from metal, in particular aluminum, or from plastic. The door is produced, in particular, from glass, the guide profile being adhesively bonded directly to the glass surface. The seal D is at least more or less of the same width as the door leaf 1, with the result that the vertical longitudinal sides of the seal D are aligned at least more or less with the door leaf 1.

In the exemplary embodiment according to FIG. 2, the lowerable seal D has an accommodating profile 6 in which the guide profile 2 is positioned. The guide profile 2 can be fixed in the accommodating profile 6 in various ways. In the exemplary embodiment illustrated here, the accommodating profile 6 has inwardly projecting shoulders 60 in the bottom region and on both longitudinal sides, the bottom edges of the guide profile 2 resting on said shoulders. It is also possible, however, for the guide profile to be adhesively bonded, fastened by means of a screw connection or fixed in some other way.

At its top end, the accommodating profile 6, in turn, has a planar bearing surface 61 which is adhesively bonded to the bottom end surface 10 of the door leaf 1.

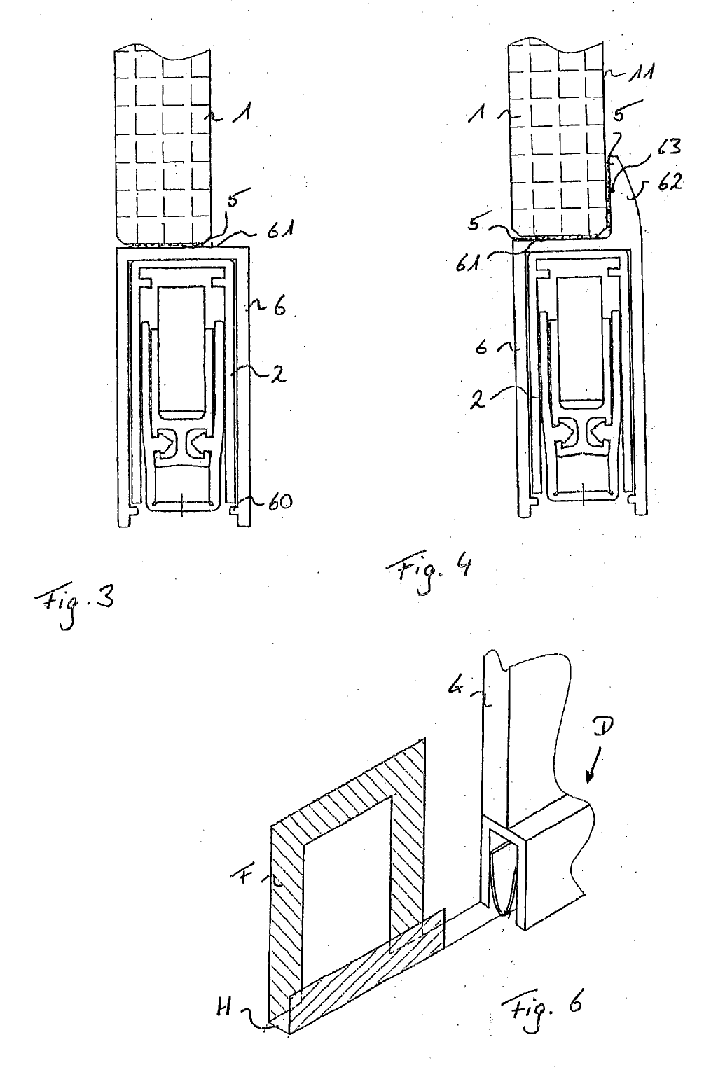

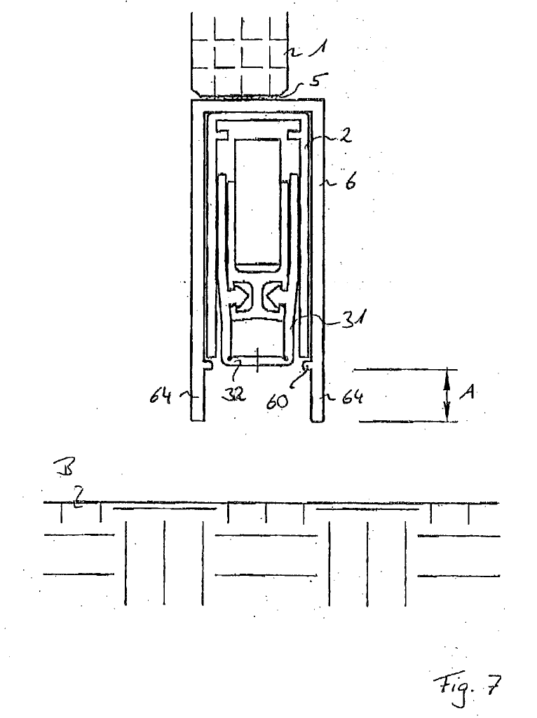

In the example illustrated here, the outer vertical longitudinal surfaces of the accommodating profile 6 are aligned with the surfaces of the door leaf 1. In the exemplary embodiment according to FIG. 3, one vertical longitudinal side of the accommodating profile 6 projects in relation to a surface 11 of the door leaf 1.

In the exemplary embodiment according to FIG. 4, an angle element 62 is integrally formed at the top end of the accommodating profile 6. The angle element 62 preferably forms a 90° angle. A first leg of the angle element 62 forms the bearing surface 61, and a second leg forms a vertical stop surface 63 for a surface 11 of the door leaf 1. It is preferable here for the second leg to be, at most, equal in length to the first leg. The stop surface 63 is preferably likewise adhesively bonded to the door surface. It is likewise possible for the angle element, in the embodiment according to FIG. 1, to be integrally formed on the guide profile.

The arrangement and fastening, provided by the invention, of the lowerable seal on a door leaf 1 make possible, as is visualized in FIG. 6, at least on one side of the door, a stepless vertical sealing surface F which is aligned with the door surface. It is possible to minimize the spacing H between the sealing surfaces, this spacing typically being not more than 7 mm. This allows the sound insulation to be improved to a considerable extent.

FIG. 7 illustrates a fifth embodiment. This embodiment may be of the same configuration in the top region as the first to fourth embodiments. In this case, it has been configured, in this region, in the same way as the third embodiment according to FIG. 3.

In contrast to the rest of the embodiments, however, the accommodating profile 6 is of longer formation. Its bottom legs 64 project beyond a bottom lip 31 of the sealing profile 3 when the latter is in the raised state. Measured from the shoulders 60, the length A of the bottom legs 64 is preferably 5-10 mm. The amount of travel of the sealing strip is correspondingly greater, with the result that the bottom lip 32 continues to rest with sealing action, in the lowered state, on the floor B.

It is possible for these bottom legs 64, during installation of the door and/or fastening of the seal D, to be shortened to the desired installation height of the door without the seal D having to be removed. It is thus easily possible to compensate for production and installation tolerances.

In another variant of FIG. 1, which is not illustrated here, the guide profile 2 has downwardly extended legs which can be shortened in accordance with the desired installation height of the door. Here too, the amount of travel of the sealing strip, once again, is sufficient for the sealing strip, in the lowered state, to rest on the floor B even if the guide profile is not shortened.

It is also possible for such seals D with shortenable bottom legs 64 and an increased amount of travel to be fastened on doors by other known methods, for example by means of screw connections.

### List of Designations

1 Door leaf

10 Bottom end surface

11 Door surface

D Lowerable seal

2 Guide profile

20 Bearing surface

3 Sealing strip

30 Carrier profile

31 Elastomeric sealing profile

32 Bottom lip

4 Lowering mechanism

5 Adhesive

6 Accommodating profile

60 Shoulder

61 Bearing surface

62 Angle element

63 Stop surface

64 Bottom leg

B Floor

P Profile rail

G Glass pane

F Vertical sealing surface

S Step

H Sealing-surface spacing

A Length of the bottom leg

1. A sill-free door with at least one door leaf (1) and with a lowerable seal (D) for sealing the door leaf (1) in the closed state of the door, preferably for sealing in the downward direction, the seal (D) having a guide profile (2), which is open in the downward direction, and a sealing strip (3), which can be displaced in the guide profile (2), the sealing strip (3) comprising a carrier profile (30) and an elastomeric sealing profile (31), which is fastened on said carrier profile, and the sealing profile (31), in the lowered state, butting against the floor (B), wherein the lowerable seal (D) is arranged beneath a, preferably the bottom, end surface (10) of the door leaf (1), and wherein it has, at its top end, a bearing surface (20, 61) which is connected to the end surface (10) of the door leaf (1) via an integral connection.

2. The door as claimed in claim 1, wherein the guide profile (2) is retained in an accommodating profile (6) which is connected to the end surface (10) of the door leaf (1).

3. The door as claimed in claim 1, wherein the guide profile (2) is connected to the end surface (10) of the door leaf (1).

4. The door as claimed in one of claims 1 to 3, wherein the bearing surface (20, 61) is adhesively bonded to the end surface (10).

5. The door as claimed in claim 1, wherein the door leaf (1) is produced from glass and the lowerable seal (D) is integrally connected to the glass.

6. The door as claimed in one of claims 1 to 3, wherein at least one vertical side of the lowerable seal (D) is aligned with a surface of the door leaf (1).

7. The door as claimed in one of claims 1 to 3, wherein two opposite vertical sides of the lowerable seal (D) are aligned with surfaces of the door leaf (1).

8. The door as claimed in one of claims 1 to 3, wherein one vertical side of the lowerable seal (D) projects in relation to a surface (11) of the door leaf (1).

9. The door as claimed in claims 2 and 8, wherein an angle element (62) is integrally formed at the top end of the seal (D), a first leg of the angle element (62) forming the bearing surface (61) and a second leg of the angle element (62) forming a stop surface (63), and wherein the stop surface (63) is adhesively bonded to a surface (11) of the door leaf (1).

10. The door as claimed in claim 9, wherein the second leg is shorter than, or equal in length to, the first leg.

11. The door as claimed in one of claims 1 to 10, wherein a bottom end surface of the guide profile (2) or of an accommodating profile (6) projects beyond an underside of the sealing profile (31) in the raised state of the latter.

12. A lowerable door seal with a guide profile (2), which is open in the downward direction, and a sealing strip (3), which can be displaced in the guide profile (2), the sealing strip (3) comprising a carrier profile (30) and an elastomeric sealing profile (31), which is fastened on said carrier profile, and the sealing profile (31), in the lowered state, butting against the floor (B), wherein a bottom end surface of the guide profile (2) or of an accommodating profile (6), in which the guide profile (2) is retained, projects beyond an underside of the sealing profile (31) in the raised state of the latter.
